(19) United States
(12) Patent Application Publication
(10) Pub. No.: US 2024/0154215 A1
(43) Pub. Date: May 9, 2024

(54) ALUMINUM PLASTIC FILM FOR LITHIUM BATTERY AND METHOD FOR MANUFACTURING THE SAME

(71) Applicant: NAN YA PLASTICS CORPORATION, TAIPEI (TW)

(72) Inventors: TE-CHAO LIAO, TAIPEI (TW); SHIOU-YEH SHENG, TAIPEI (TW); TENG-KO MA, TAIPEI (TW); CHING-YAO YUAN, TAIPEI (TW); Chao-Hsien Lin, TAIPEI (TW); CHIA-YU LIN, Taoyuan City (TW); YUN-BIN HSI, TAIPEI (TW); HAN-YI LEE, Taoyuan City (TW); SHUN-CHIEH YANG, New Taipei City (TW)

(21) Appl. No.: 18/170,539

(22) Filed: Feb. 17, 2023

(30) Foreign Application Priority Data
Nov. 4, 2022 (TW) 111142113

(51) Int. Cl. H01M 50/129; B32B 7/12; B32B 15/085; B32B 15/088; B32B 15/09; B32B 15/20; B32B 27/32; B32B 27/34; B32B 27/36; B32B 37/12; C08J 5/12; C09J 5/00; C09J 11/06; C09J 123/08; H01M 50/105; H01M 50/119; H01M 50/121

(52) U.S. Cl. CPC H01M 50/129; B32B 7/12; B32B 15/085; B32B 15/088; B32B 15/09; B32B 15/20; B32B 27/32; B32B 27/34; B32B 27/36; B32B 37/1284; C08J 5/125; C09J 5/00; C09J 11/06; C09J 123/0815; H01M 50/105; H01M 50/119; H01M 50/121; C08K 5/1539; C09J 2400/166; C09J 2423/04; C09J 2423/108

(57) ABSTRACT

An aluminum plastic film for a lithium battery and a method for manufacturing the same are provided. The method includes steps as follows: preparing a polyolefin adhesive; coating the polyolefin adhesive onto one surface of an aluminum foil layer; disposing an inner polyolefin layer onto the polyolefin adhesive; and drying the polyolefin adhesive, so that a polyolefin adhesive layer is formed between the aluminum foil layer and the inner polyolefin layer. Components of the polyolefin adhesive include a modified polyolefin polymer and a hardener. The modified polyolefin polymer has a modified group, a structure of the modified group contains maleic anhydride, and a molecular weight of the modified polyolefin polymer ranges from 100,000 g/mol to 200,000 g/mol.

### CROSS-REFERENCE TO RELATED PATENT APPLICATION

This application claims the benefit of priority to Taiwan Patent Application No. 111142113, filed on Nov. 4, 2022. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an aluminum plastic film and a method for manufacturing the same, and more particularly to an aluminum plastic film for a lithium battery and a method for manufacturing the same.

### BACKGROUND OF THE DISCLOSURE

According to different packaging methods, lithium batteries can be categorized into cylindrical cells, prismatic cells, and pouch cells. Compared with other types of lithium batteries, the pouch cells provide advantages that include improved safety and having a lighter weight.

An aluminum plastic film is an important material for manufacturing the pouch cell. The aluminum plastic film is wrapped around a battery cell and an electrolyte, so as to protect the contents of a battery. Since it is necessary for the aluminum plastic film to be in contact with the electrolyte for a long period of time, the aluminum plastic film is required to have a good electrolyte-resistant property. In addition, the aluminum plastic film also needs to be capable of having a packaging effect.

The structure of the aluminum plastic film includes an inner layer, an outer layer, and an aluminum foil layer located therebetween. The inner layer is located on an inner side of the aluminum plastic film for being in contact with the electrolyte, and can be used for heat sealing. The outer layer is located on an outer side of the aluminum plastic film for being in contact with the outside air.

Due to material differences, a polyolefin adhesive can be disposed between the aluminum foil layer and the inner layer, and a polyester adhesive can be disposed between the aluminum foil layer and the outer layer, so as to achieve a joining effect.

It should be noted that, in the pouch cell, the inner layer will be in contact with the electrolyte. As such, in addition to the inner layer, the polyolefin adhesive also needs to be electrolyte-resistant. However, in order to achieve good electrolyte resistance, the conventional polyolefin adhesive has a high unit price, which prevents the overall price of the pouch cell from being reduced.

Therefore, how production costs of the polyolefin adhesive can be reduced, and how good electrolyte resistance can be maintained through an improvement in components has become one of the important issues to be solved in this industry.

### SUMMARY OF THE DISCLOSURE

In response to the above-referenced technical inadequacies, the present disclosure provides an aluminum plastic film for a lithium battery and a method for manufacturing the same.

In one aspect, the present disclosure provides a method for manufacturing an aluminum plastic film for a lithium battery. The method includes: preparing a polyolefin adhesive; coating the polyolefin adhesive onto one surface of an aluminum foil layer; disposing an inner polyolefin layer onto the polyolefin adhesive; and drying the polyolefin adhesive, so that a polyolefin adhesive layer is formed between the aluminum foil layer and the inner polyolefin layer. Components of the polyolefin adhesive include a modified polyolefin polymer and a hardener. The modified polyolefin polymer has a modified group, a structure of the modified group contains maleic anhydride, and a molecular weight of the modified polyolefin polymer ranges from 100,000 g/mol to 200,000 g/mol.

In certain embodiments, an acid value of the modified polyolefin polymer ranges from 0.1 mgKOH/g to 10 mgKOH/g.

In certain embodiments, the step of preparing the polyolefin adhesive includes: melting and mixing a polyolefin pellet and a modifier to form a modified pellet at a temperature of from 160° C. to 230° C., and using the modified pellet to prepare the polyolefin adhesive. A material of the modified pellet is the modified polyolefin polymer.

In certain embodiments, the modifier is selected from the group consisting of maleic anhydride, methyl tetrahydrophthalic anhydride (MTHPA), 3,4,5,6-tetrahydrophthalic anhydride, 1,2,3,6-tetrahydrophthalic anhydride (THPA), methylhexahydrophthalic anhydride (MHHPA), methyl nadic anhydride (MNA), and 2,3-naphthalenedicarboxylic anhydride.

In certain embodiments, the step of preparing the polyolefin adhesive includes: adding a mixed solvent to dissolve a modified pellet, and adding the hardener to form the polyolefin adhesive. A material of the modified pellet is the modified polyolefin polymer, the mixed solvent includes a non-polar solvent and a polar solvent, and a mass ratio of the non-polar solvent to the polar solvent ranges from 4:1 to 3:2.

In certain embodiments, the non-polar solvent is methylcyclohexane, and the polar solvent is methyl ethyl ketone, ethyl acetate, or a mixture thereof.

In certain embodiments, the modified polyolefin polymer is a propylene random copolymer, and the propylene random copolymer is polymerized from a propylene monomer. Based on a total weight of the propylene random copolymer being 100 wt %, a proportion of the propylene monomer is greater than 50 wt %.

In certain embodiments, the modified polyolefin polymer is a propylene random copolymer, and the propylene random copolymer is polymerized from an ethylene monomer, a propylene monomer, and a butylene monomer.

In certain embodiments, a melting point of the modified polyolefin polymer ranges from 60° C. to 90° C. The modified polyolefin polymer has a melt flow index (MFI) of from 6 g/10 min to 30 g/10 min when measured under conditions of 120° C. and a load of 2.16 kg.

In certain embodiments, the method further includes: coating a polyester adhesive onto another surface of the aluminum foil layer; disposing an outer layer onto the polyester adhesive, in which the outer layer is a nylon layer or a polyester layer; and drying the polyester adhesive, so that a polyester adhesive layer is formed between the aluminum foil layer and the outer layer.

In another aspect, the present disclosure provides an aluminum plastic film for a lithium battery. The aluminum plastic film is manufactured by the above-mentioned method. An electrolyte-resistant adhesive strength between the polyolefin adhesive layer and the aluminum foil layer is greater than 15 N/15 mm. The electrolyte-resistant adhesive strength between the polyolefin adhesive layer and the aluminum foil layer is greater than 12.5 N/15 mm after 168 hours at a temperature of 85° C.

Therefore, in the aluminum plastic film for the lithium battery and the method for manufacturing the same provided by the present disclosure, by virtue of “the modified polyolefin polymer having a modified group,” “a structure of the modified group containing maleic anhydride,” and “a molecular weight of the modified polyolefin polymer ranging from 100,000 g/mol to 200,000 g/mol,” an electrolyte-resistant adhesive strength of the aluminum plastic film for the lithium battery can be enhanced.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a side view showing a structure of an aluminum plastic film for a lithium battery according to the present disclosure; and

FIG. 2 is a flowchart of a method for manufacturing the aluminum plastic film for the lithium battery according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

In order to reduce manufacturing costs, the present disclosure provides an aluminum plastic film for a lithium battery and a method for manufacturing the same, in which a specific polyolefin adhesive is used to bind an aluminum foil layer and an inner polyolefin layer. Accordingly, an electrolyte-resistant adhesive strength of the aluminum plastic film of the present disclosure is superior to that of an aluminum plastic film currently available on the market. Even when being placed in a high temperature environment for a long time, the aluminum plastic film of the present disclosure can still maintain a good electrolyte-resistant adhesive strength.

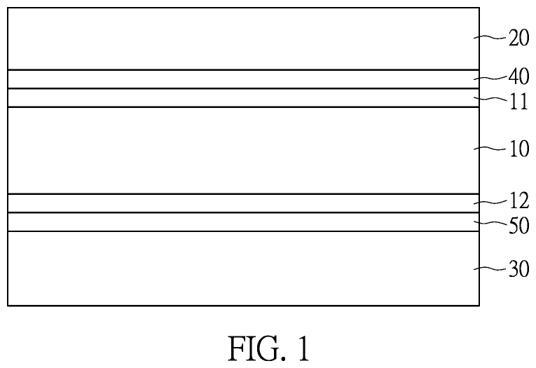

Referring to FIG. 1, the aluminum plastic film for the lithium battery in the present disclosure includes an aluminum foil layer 10, an inner polyolefin layer 20, and an outer layer 30.

The aluminum foil layer 10 is disposed between the inner polyolefin layer 20 and the outer layer 30. An anti-corrosion treatment can be performed on two opposite surfaces of the aluminum foil layer 10 for respective formation of anti-corrosion treatment layers 11, 12. In this way, an effect of protecting the aluminum foil layer 10 can be achieved. The inner polyolefin layer 20 serves as an inner surface of the aluminum plastic film, and is in contact with an electrolyte after packaging. The outer layer 30 serves as an outer surface of the aluminum plastic film, and is in contact with the outside air after packaging. The outer layer 30 can be a nylon layer or a polyester layer. However, the present disclosure is not limited thereto.

Due to material differences, the polyolefin adhesive can be coated between the aluminum foil layer 10 and the inner polyolefin layer 20 for forming a polyolefin adhesive layer 40, so as to achieve an effect of adhering the aluminum foil layer 10 to the inner polyolefin layer 20. In addition, a polyester adhesive can be coated between the aluminum foil layer 10 and the outer layer 30 for forming a polyester adhesive layer 50, so as to achieve an effect of adhering the aluminum foil layer 10 to the outer layer 30.

In one exemplary embodiment, a thickness of the polyolefin adhesive layer 40 ranges from 2 μm to 10 μm. Preferably, the thickness of the polyolefin adhesive layer 40 ranges from 3 μm to 5 μm.

Based on the structure of the above-mentioned aluminum plastic film, in addition to being capable of adhering the aluminum foil layer 10 to the inner polyolefin layer 20, the polyolefin adhesive is also required to have a certain electrolyte-resistant adhesive strength, so as to maintain an adhesive strength between the inner polyolefin layer 20 and the aluminum foil layer 10.

The polyolefin adhesive of the present disclosure has an appropriate melting point, so that processing can be carried out without an overly high temperature condition. Such a low-temperature processing characteristic can prevent physical properties of the inner polyolefin layer 20 from being negatively affected. Further, the polyolefin adhesive of the present disclosure has an appropriate viscosity and is suitable for a coating process. Specific processes of preparing the polyolefin adhesive will be illustrated below.

In the present disclosure, components of the polyolefin adhesive include a modified polyolefin polymer and a hardener. Types of the hardener can be selected according to requirements. An added amount of the hardener ranges from 1 phr to 10 phr relative to 100 phr of the modified polyolefin polymer. In one exemplary embodiment, the hardener is a polyisocyanate hardener (e.g., DESMODURR ultra N 3300). However, the present disclosure is not limited thereto.

The modified polyolefin polymer is a propylene random copolymer. That is, the modified polyolefin polymer is formed by co-polymerization of a propylene monomer and other monomers. Based on a total weight of the propylene random copolymer being 100 wt %, a proportion of the propylene monomer is greater than 50 wt %. In one exemplary embodiment, the propylene random copolymer is polymerized from an ethylene monomer, the propylene monomer, and a butylene monomer.

The modified polyolefin polymer has a modified group, and the modified group can be grafted onto a main chain or a branch of the modified polyolefin polymer. In one exemplary embodiment, the modified group is formed from maleic anhydride or a maleic anhydride derivative (a compound in which its structure contains the maleic anhydride). Therefore, a structure of the modified group contains the maleic anhydride. Specifically, through grafting, the modified group can be formed from the maleic anhydride, methyl tetrahydrophthalic anhydride, 3,4,5,6-tetrahydrophthalic anhydride, 1,2,3,6-tetrahydrophthalic anhydride, methylhexahydrophthalic anhydride, methyl nadic anhydride, or 2,3-naphthalenedicarboxylic anhydride.

The modified group of the modified polyolefin polymer can reduce a melting point of the propylene random copolymer, thereby reducing an operation temperature of the polyolefin adhesive during attachment processing or other processing procedures. When a processing temperature is reduced, physical properties of other layer bodies (e.g., the above-mentioned inner polyolefin layer) can be prevented from changing during an adhesion process. In one exemplary embodiment, a melting point of the modified polyolefin polymer ranges from 60° C. to 90° C. Preferably, the melting point of the modified polyolefin polymer ranges from 75° C. to 85° C.

Moreover, the modified polyolefin polymer has a melt flow index of from 6 g/10 min to 30 g/10 min (preferably from 9 g/10 min to 20 g/10 min) The melt flow index of the modified polyolefin polymer is measured under conditions of 120° C. and a load of 2.16 kg.

For the modified group of the modified polyolefin polymer, its structure contains the maleic anhydride. In one exemplary embodiment, an acid value of the modified polyolefin polymer ranges from 0.1 mgKOH/g to 10 mgKOH/g (preferably from 4 mgKOH/g to 8 mgKOH/g).

In the present disclosure, a molecular weight of the modified polyolefin polymer is controlled, so as to enhance processability of the polyolefin adhesive and enhance a binding effect between the aluminum foil layer 10 and the inner polyolefin layer 20.

Specifically, the molecular weight of the modified polyolefin polymer ranges from 100,000 g/mol to 200,000 g/mol (preferably from 130,000 g/mol to 170,000 g/mol). When the molecular weight of the modified polyolefin polymer is greater than 200,000 g/mol, the viscosity of the polyolefin adhesive will be too high, thereby causing difficulty in coating and processing. When the molecular weight of the modified polyolefin polymer is less than 100,000 g/mol, an adhering effect of the polyolefin adhesive will be negatively affected.

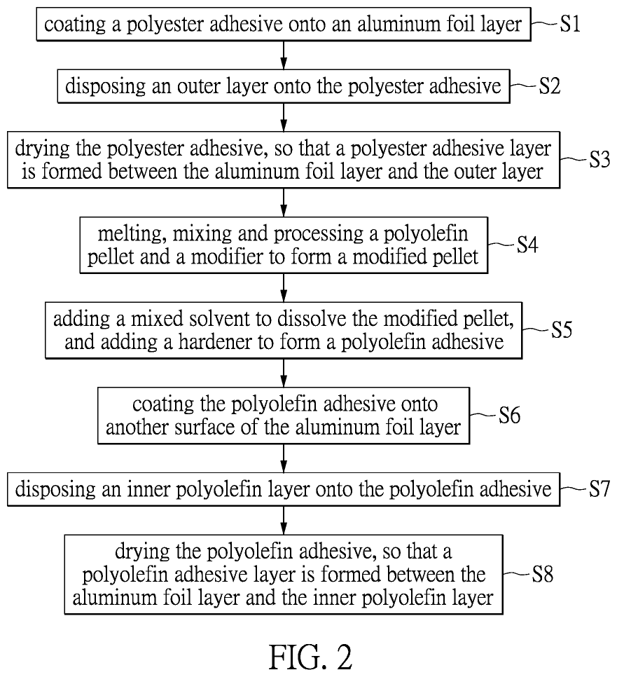

Reference is made to FIG. 2. In the present disclosure, the method for manufacturing the aluminum plastic film for the lithium battery includes: coating the polyester adhesive onto the aluminum foil layer (step S1); disposing an outer layer onto the polyester adhesive (step S2); drying the polyester adhesive, so that a polyester adhesive layer is formed between the aluminum foil layer and the outer layer (step S3); melting, mixing and processing a polyolefin pellet and a modifier to form a modified pellet (step S4); adding a mixed solvent to dissolve the modified pellet, and adding the hardener to form the polyolefin adhesive (step S5); coating the polyolefin adhesive onto another surface of the aluminum foil layer (step S6); disposing the inner polyolefin layer onto the polyolefin adhesive (step S7); and drying the polyolefin adhesive, so that a polyolefin adhesive layer is formed between the aluminum foil layer and the inner polyolefin layer (step S8).

It should be noted that the processes of preparing the polyolefin adhesive of the present disclosure include the above-mentioned step S4 and step S5.

In step S4, the polyolefin pellet and the modifier are melted and mixed at a temperature of from 160° C. to 230° C. During the mixing process, a reaction occurs between the polyolefin pellet and the modifier, such that the modifier is grafted onto the propylene random copolymer and the above-mentioned modified polyolefin polymer is formed. After the modified polyolefin polymer is fed into an extruder, the modified pellet can be extruded and obtained.

In one exemplary embodiment, a material of the polyolefin pellet is the propylene random copolymer. The modifier is selected from the group consisting of maleic anhydride, methyl tetrahydrophthalic anhydride, 3,4,5,6-tetrahydrophthalic anhydride, 1,2,3,6-tetrahydrophthalic anhydride, methylhexahydrophthalic anhydride, methyl nadic anhydride, and 2,3-naphthalenedicarboxylic anhydride. An added amount of the modifier ranges from 0.5 phr to 1.5 phr relative to 100 phr of the polyolefin pellet. It should also be noted that a specific grafting amount of the modified group is quantified based on an acid value, and the added amount of the modifier is only provided for ease of description of the operation steps.

In step S5, the mixed solvent having a specific composition is prepared for dissolving the modified pellet, and then the hardener is added, so as to complete preparation of the polyolefin adhesive of the present disclosure. The viscosity of the polyolefin adhesive ranges from 50 cps to 200 cps, and a solid content ranges from 12% to 18%, but the present disclosure is not limited thereto.

In the present disclosure, a non-polar solvent and a polar solvent are selected as the mixed solvent. The polyolefin adhesive can be prepared to have an excellent processability and a good adhesive property through the mixed solvent that has specific components and ratios. In one exemplary embodiment, an added amount of the non-polar solvent is greater than an added amount of the polar solvent. When the added amount of the polar solvent is greater than that of the non-polar solvent, the polyolefin adhesive will precipitate block-shaped polyolefin and cannot be processed. Preferably, a ratio of the non-polar solvent to the polar solvent ranges from 4:1 to 3:2.

For example, the non-polar solvent can be methylcyclohexane, cyclohexane, n-hexane, or a combination thereof. The polar solvent can be methyl ethyl ketone, ethyl acetate, methyl isobutyl ketone, n-propyl acetate, or a combination thereof. Preferably, the non-polar solvent is the methylcyclohexane, and the polar solvent is the methyl ethyl ketone, the ethyl acetate, or a mixture thereof. The hardener can be, for example, DESMODUR® ultra N 3300, DESMODUR® ultra N 3600, or a combination thereof.

The aluminum plastic film for the lithium battery in the present disclosure has a good electrolyte-resistant adhesive strength, and is capable of maintaining the same even in a high temperature environment for a long period of time. As evidence for the above-mentioned advantages, aluminum plastic films of Examples 1 to 3 and Comparative Examples 1 and 2 are prepared according to the foregoing steps S1 to S8.

### Examples 1 to 3

An aluminum foil (model: 8021; thickness: 40 μm) is used as the aluminum foil layer, and the material of the selected polyolefin pellet is the propylene random copolymer (which is polymerized from the ethylene monomer, the propylene monomer, and the butylene monomer). The polyolefin pellet and the modifier are melted and mixed at a temperature of 220° C., and the modified pellet is manufactured by the extruder. The non-polar solvent and the polar solvent are used to dissolve the modified pellet, and an appropriate amount of the hardener is added for preparing and forming the polyolefin adhesive. In Examples 1 to 3, the methylcyclohexane (MCH) is selected as the non-polar solvent, and the methyl ethyl ketone (MEK) and the ethyl acetate (EAC) are selected as the polar solvent.

Then, the polyolefin adhesive is coated onto one surface of the aluminum foil layer. An unstretched polypropylene film (model: DG; thickness: 40 μm) is disposed onto the polyolefin adhesive for being used as the inner polyolefin layer, and one laminated structure is formed. The laminated structure is dried at a temperature of 105° C., and the polyolefin adhesive is formed into the polyolefin adhesive layer having a thickness of 4 μm.

The polyester adhesive is coated onto another surface of the aluminum foil layer. The polyester layer (model: RX-F; thickness: 25 μm) is disposed onto the polyester adhesive for being used as the outer layer. After being dried at a temperature of 105° C., the polyester adhesive is formed into the polyester adhesive layer having a thickness of 4 μm.

Materials and operation processes that are used are similar in Examples 1 to 3. The difference between Examples 1 to 3 resides in that their polyolefin pellets have molecular weights different from one another. However, said molecular weights are within a range from 100,000 g/mol to 200,000 g/mol.

### Comparative Examples 1 and 2

Comparative Examples 1 and 2 and Examples 1 to 3 have similar operation processes. Their difference resides in that the molecular weight of the polyolefin pellet in Comparative Examples 1 and 2 is not within the range from 100,000 g/mol to 200,000 g/mol (which will be not reiterated herein).

### Comparative Example 3

Comparative Example 3 and Examples 1 to 3 have similar operation processes. Their difference resides in that the propylene random copolymer in Comparative Example 3 is not modified by the modifier (i.e., the acid value is 0). Instead, the polyolefin adhesive is directly prepared by use of the non-polar solvent and the polar solvent, and specific steps thereof are illustrated below.

The aluminum foil (model: 8021; thickness: 40 μm) is used as the aluminum foil layer, and the material of the selected polyolefin pellet is the propylene random copolymer (which is polymerized from the ethylene monomer, the propylene monomer, and the butylene monomer). The non-polar solvent and the polar solvent are used to dissolve the modified pellet, and an appropriate amount of the hardener is added for preparing and forming the polyolefin adhesive. In Comparative Examples 1 to 3, the methylcyclohexane (MCH) is selected as the non-polar solvent, and the methyl ethyl ketone (MEK) and the ethyl acetate (EAC) are selected as the polar solvent.

Then, the polyolefin adhesive is coated onto one surface of the aluminum foil layer. The unstretched polypropylene film (model: DG; thickness: 40 μm) is disposed onto the polyolefin adhesive for being used as the inner polyolefin layer, and one laminated structure is formed. The laminated structure is dried at a temperature of 105° C., and the polyolefin adhesive is formed into the polyolefin adhesive layer having a thickness of 4 μm.

The polyester adhesive is coated onto another surface of the aluminum foil layer. The polyester layer (model: RX-F; thickness: 25 μm) is disposed onto the polyester adhesive for being used as the outer layer. After being dried at a temperature of 105° C., the polyester adhesive is formed into the polyester adhesive layer having a thickness of 4 μm.

### Comparative Example 4

Comparative Example 4 and Comparative Example 3 have similar operation processes, both of which use unmodified polyolefin adhesives. Their difference resides in that the polyolefin adhesive used in Comparative Example 4 is one currently available on the market (model: ZAR-1902B). Said polyolefin adhesive is directly coated onto the aluminum foil layer for forming the polyolefin adhesive layer, and specific steps thereof are illustrated below.

The aluminum foil (model: 8021; thickness: 40 μm) is used as the aluminum foil layer. The polyolefin adhesive is coated onto one surface of the aluminum foil layer. Then, the unstretched polypropylene film (model: DG; thickness: 40 μm) is disposed onto the polyolefin adhesive for being used as the inner polyolefin layer, and one laminated structure is formed. The laminated structure is dried at a temperature of 105° C., and the polyolefin adhesive is formed into the polyolefin adhesive layer having a thickness of 4 μm.

The polyester adhesive is coated onto another surface of the aluminum foil layer. The polyester layer (model: RX-F; thickness: 25 μm) is disposed onto the polyester adhesive for being used as the outer layer. After being dried at a temperature of 105° C., the polyester adhesive is formed into the polyester adhesive layer having a thickness of 4 μm.

In Table 1, components, properties, and added amounts of the polyolefin pellet and the modifier in Examples 1 to 3 and Comparative Examples 1 to 3 during step S4 are shown. If no unit is specifically provided, the unit is phr. In Table 2, components, properties, and added amounts of the modified pellet or the polyolefin pellet, the non-polar solvent, the polar solvent, and the hardener in Examples 1 to 3 and Comparative Examples 1 to 3 during step S5 are shown. If no unit is specifically provided, the unit is phr.

The aluminum plastic films of Examples 1 to 3 and Comparative Examples 1 to 4 undergo an adhesive strength test, and results thereof are shown in Table 3. During the adhesive strength test, the above-mentioned aluminum plastic film is cut into a sample having a size that is 150 mm in length and 15 mm in width. Then, a knife blade is used to slightly cut the sample, and a cut line is formed at a position parallel to and spaced 15 mm from a short side of the sample. After repeated folding along the cut line, the unstretched polypropylene film is slowly peeled off from the aluminum foil layer. When the unstretched polypropylene film is completely separated from the aluminum foil layer for more than 10 mm, an adhesive strength between the unstretched polypropylene film and the aluminum foil layer can be measured, so as to obtain an initial adhesive strength.

Another sample is acquired and immersed in the electrolyte (model: FPC-301) at a temperature of 85° C. for 168 hours. Then, the above-mentioned steps of forming the cut line, peeling off the unstretched polypropylene film, and measuring the adhesive strength are repeated, so as to obtain the adhesive strength of the aluminum plastic film after being immersed in the electrolyte.

In a peel test, chucks are spaced apart from one another by 50 mm. The peeling is carried out by the T-peel test, a peel test speed is 200 mm/min, and a working distance is more than 50 mm. The electrolyte (model: FPC-301) includes lithium hexafluorophosphate (LiPF₆) having a concentration of 1 M. The solvent includes ethylene carbonate (EC), diethyl carbonate (DEC), and dimethyl carbonate (DMC) at a weight ratio of 1:1:1.

TABLE 1

| | | | | | Compara- | Compara- | Compara- |
|---|---|---|---|---|---|---|---|
| | | | | | tive | tive | tive |
| (phr) | | Example 1 | Example 2 | Example 3 | Example 1 | Example 2 | Example 3 |
| Po [symbol] | Type | Propylene | Propylene | Propylene | Propylene | Propylene | Propylene |
| | | random | random | random | random | random | random |
| | | copolymer | copolymer | copolymer | copolymer | copolymer | copolymer |
| | Composi- | Polymerized from an ethylene monomer, a | | | | | |
| | tion | propylene monomer, and a butylene monomer | | | | | |
| | Molecular | 100,000 | 150,000 | 200,000 | 70,000 | 220,000 | 150,000 |
| | weight | | | | | | |
| | (g/mol) | | | | | | |
| | Added | 100 | 100 | 100 | 100 | 100 | 100 |
| | amount | | | | | | |
| Modifier | Type | Maleic | Maleic | Maleic | Maleic | Maleic | Unmodified |
| [symbol] | | anhydride | anhydride | anhydride | anhydride | anhydride | |
| | Added | 1.0 | 1.0 | 1.0 | 1.0 | 1.0 | 0 |
| | amount | | | | | | |

[symbol]

indicates data missing or illegible when filed

TABLE 2

| | | | | | Compara- | Compara- | Compara- |
|---|---|---|---|---|---|---|---|
| | | | | | tive | tive | tive |
| (phr) | | Example 1 | Example 2 | Example 3 | Example 1 | Example 2 | Example 3 |
| Modified | Added | 20 | 20 | 20 | 20 | 20 | 20 |
| pellet/ | amount | | | | | | |
| Polyolefin | Acid | 5.8 | 5.8 | 5.8 | 5.8 | 5.8 | 0 |
| pellet | value | | | | | | |
| | (mgKOH/g) | | | | | | |
| Non-polar | Type | MCH | MCH | MCH | MCH | MCH | MCH |
| solvent | Added | 56 | 56 | 56 | 56 | 56 | 56 |
| | amount | | | | | | |
| Polar | Type | MEK and | MEK and | MEK and | MEK and | MEK and | MEK and |
| solvent | | EAC | EAC | EAC | EAC | EAC | EAC |
| | Added | 24 | 24 | 24 | 24 | 24 | 24 |
| | amount | | | | | | |
| Ratio of non-polar | | 70/30 | 70/30 | 70/30 | 70/30 | 70/30 | 70/30 |
| solvent to polar | | | | | | | |
| solvent | | | | | | | |
| Hardener | Type | NCO | NCO | NCO | NCO | NCO | NCO |
| | Added | 3.5 | 3.5 | 3.5 | 3.5 | 3.5 | 3.5 |
| | amount | | | | | | |

TABLE 3

| | | | | | Compara- | Compara- | Compara- | Compara- |
|---|---|---|---|---|---|---|---|---|
| | | | | | tive | tive | tive | tive |
| (N/15 mm) | | Example 1 | Example 2 | Example 3 | Example 1 | Example 2 | Example 3 | Example 4 |
| Adhesive | Initial | 15.3 | 15.5 | 15.6 | 14.9 | 14.3 | 15.4 | 14.0 |
| strength | After | 12.8 | 13.7 | 13.1 | 8.2 | 11.6 | 2.1 | 10.5 |
| | immersion in | | | | | | | |
| | electrolyte | | | | | | | |

According to the results of Table 3, the aluminum plastic film of the present disclosure has a good electrolyte-resistant adhesive strength (greater than 15 N/15 mm), and is capable of maintaining the same (greater than 12 N/15 mm) even under high temperature conditions and after contacting the electrolyte for a long period of time. Preferably, in the present disclosure, the electrolyte-resistant adhesive strength of the aluminum plastic film ranges from 15.2 N/15 mm to 18 N/15 mm. The electrolyte-resistant adhesive strength of the aluminum plastic film ranges from 12 N/15 mm to 16 N/15 mm after 168 hours at a temperature of 85° C.

It can be observed from Comparative Example 3 that the electrolyte-resistant adhesive strength of the aluminum plastic film can be significantly enhanced by using the modified polyolefin polymer of the present disclosure (as compared with using an unmodified polyolefin polymer). In particular, the electrolyte-resistant adhesive strength of the aluminum plastic film that is situated in a high temperature environment and in contact with the electrolyte for a long time can be enhanced.

It can be observed from Comparative Example 4 that, as compared with the polyolefin adhesive currently available on the market, the aluminum plastic film can have an improved electrolyte-resistant adhesive strength by using the modified polyolefin polymer of the present disclosure (an effect that is unachievable for the polyolefin adhesive currently available on the market).

From Comparative Examples 1 and 2, it can be observed that the aluminum plastic film can have a good electrolyte-resistant adhesive strength by controlling the molecular weight of the modified polyolefin polymer to range from 100,000 g/mol to 200,000 g/mol. If the molecular weight of the modified polyolefin polymer is less than 100,000 g/mol or greater than 200,000 g/mol, it will not be impossible to achieve the effect of having a good electrolyte-resistant adhesive strength of the present disclosure.

### BENEFICIAL EFFECTS OF THE EMBODIMENTS

In conclusion, in the aluminum plastic film for the lithium battery and the method for manufacturing the same provided by the present disclosure, by virtue of “the modified polyolefin polymer having a modified group,” “a structure of the modified group containing maleic anhydride,” and “a molecular weight of the modified polyolefin polymer ranging from 100,000 g/mol to 200,000 g/mol,” the electrolyte-resistant adhesive strength of the aluminum plastic film for the lithium battery can be enhanced.

More specifically, a specific polyolefin adhesive (especially the modified polyolefin polymer of the polyolefin adhesive) is selected in the present disclosure. In the present disclosure, the propylene random copolymer is selected as the main material of the modified polyolefin polymer, and the modifier that contains the maleic anhydride in its structure is used for modifying the propylene random copolymer, such that the modified group that contains the maleic anhydride in its structure is grafted onto the propylene random copolymer. Apart from selection of the components, properties (e.g., the acid value, the molecular weight, the melting point, and the melt flow index) of the modified polyolefin polymer are also controlled in the present disclosure. In this way, properties of the propylene random copolymer can be adjusted, and the electrolyte-resistant adhesive strength of the aluminum plastic film can be improved without negatively affecting the adhering effect of the polyolefin adhesive. Further, the polyolefin adhesive has an advantage of easy processing.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for manufacturing an aluminum plastic film for a lithium battery, comprising:
preparing a polyolefin adhesive, wherein components of the polyolefin adhesive include a modified polyolefin polymer and a hardener; wherein the modified polyolefin polymer has a modified group, a structure of the modified group contains maleic anhydride, and a molecular weight of the modified polyolefin polymer ranges from 100,000 g/mol to 200,000 g/mol;
coating the polyolefin adhesive onto one surface of an aluminum foil layer;
disposing an inner polyolefin layer onto the polyolefin adhesive; and
drying the polyolefin adhesive, so that a polyolefin adhesive layer is formed between the aluminum foil layer and the inner polyolefin layer.

2. The method according to claim 1, wherein an acid value of the modified polyolefin polymer ranges from 0.1 mgKOH/g to 10 mgKOH/g.

3. The method according to claim 1, wherein the step of preparing the polyolefin adhesive includes: melting and mixing a polyolefin pellet and a modifier to form a modified pellet at a temperature of from 160° C. to 230° C., and using the modified pellet to prepare the polyolefin adhesive; wherein a material of the modified pellet is the modified polyolefin polymer.

4. The method according to claim 3, wherein the modifier is selected from the group consisting of maleic anhydride, methyl tetrahydrophthalic anhydride, 3,4,5,6-tetrahydrophthalic anhydride, 1,2,3,6-tetrahydrophthalic anhydride, methylhexahydrophthalic anhydride, methyl nadic anhydride, and 2,3-naphthalenedicarboxylic anhydride.

5. The method according to claim 1, wherein the step of preparing the polyolefin adhesive includes: adding a mixed solvent to dissolve a modified pellet, and adding the hardener to form the polyolefin adhesive; wherein a material of the modified pellet is the modified polyolefin polymer, the mixed solvent includes a non-polar solvent and a polar solvent, and a mass ratio of the non-polar solvent to the polar solvent ranges from 4:1 to 3:2.

6. The method according to claim 5, wherein the non-polar solvent is methylcyclohexane, and the polar solvent is methyl ethyl ketone, ethyl acetate, or a mixture thereof.

7. The method according to claim 1, wherein the modified polyolefin polymer is a propylene random copolymer, and the propylene random copolymer is polymerized from a propylene monomer; wherein, based on a total weight of the propylene random copolymer being 100 wt %, a proportion of the propylene monomer is greater than 50 wt %.

8. The method according to claim 1, wherein the modified polyolefin polymer is a propylene random copolymer, and the propylene random copolymer is polymerized from an ethylene monomer, a propylene monomer, and a butylene monomer.

9. The method according to claim 1, wherein a melting point of the modified polyolefin polymer ranges from 60° C. to 90° C.; wherein the modified polyolefin polymer has a melt flow index of from 6 g/10 min to 30 g/10 min when measured under conditions of 120° C. and a load of 2.16 kg.

10. The method according to claim 1, further comprising:
coating a polyester adhesive onto another surface of the aluminum foil layer;
disposing an outer layer onto the polyester adhesive, wherein the outer layer is a nylon layer or a polyester layer; and
drying the polyester adhesive, so that a polyester adhesive layer is formed between the aluminum foil layer and the outer layer.

11. An aluminum plastic film for a lithium battery, characterized in that the aluminum plastic film is manufactured by the method as claimed in claim 1, wherein an electrolyte-resistant adhesive strength between the polyolefin adhesive layer and the aluminum foil layer is greater than 15 N/15 mm; wherein the electrolyte-resistant adhesive strength between the polyolefin adhesive layer and the aluminum foil layer is greater than 12.5 N/15 mm after 168 hours at a temperature of 85° C.
